(19) United States
(12) Patent Application Publication
(10) Pub. No.: US 2022/0224547 A1
(43) Pub. Date: Jul. 14, 2022

(54) PROVISIONING AND AUTHENTICATING DEVICE CERTIFICATES

(71) Applicant: Noodle Technology Inc., San Francisco, CA (US)

(72) Inventors: Micha Anthenor BENOLIEL, San Francisco, CA (US); Lucien LOISEAU, San Francisco, CA (US); Eliott Quentin Eric TEISSONNIERE, San Francisco, CA (US); Garrett Edward KINSMAN, San Francisco, CA (US)

(21) Appl. No.: 17/753,862

(22) PCT Filed: Sep. 16, 2020
(86) PCT No.: PCT/US2020/051127

§ 371 Date: Mar. 16, 2022

Related U.S. Application Data
(60) Provisional application No. 62/901,149, filed on Sep. 16, 2019.

(51) Int. Cl. H04L 9/32; H04L 9/08

(52) U.S. Cl. CPC H04L 9/3247; H04L 9/3263; H04L 9/0825; H04L 9/0866; H04L 9/3271

(57) ABSTRACT

In one example, a method may include generating a whitelist at a whitelisting authority, adding the whitelist to a PKI smart contract, adding one or more signing keys to the PKI smart contract, provisioning a device with a keypair by a manufacturer, sending a challenge to the device from a user, receiving a reply from the device at the user, and verifying a certificate and revocation status for the device by the user. The reply may include a challenge signature. The certificate and revocation status may be verified by the user using the PKI smart contract.

### BACKGROUND

The present disclosure generally relates to provisioning and authenticating certificates for networked “smart” devices. In particular, the present disclosure describes a system and method to certify and identify devices in a cryptographically safe manner.

The Internet of Things (IoT) is the concept of connecting ordinary devices like lights and doors to a computer network to make them “intelligent.” An embedded system or a computer connects each device together in a network and to the internet. The connections allow each device to collect and exchange data, and permits them to be controlled remotely or permits them to remain updated, or be controlled remotely or by setting rules or chains of actions.

The use of IoT devices is expanding into many aspects of human life, and experts estimate that the IoT will have almost 50 billion devices by 2020. IoT devices are becoming common in households, with appliances such as lighting fixtures, thermostats, home security systems, cameras, smart speakers and other home appliances becoming widespread. Increasingly, IoT devices are being used for commercial and industrial contexts. For example, IoT devices can be used for asset tracking and management, for example, in commercial and industrial applications.

IoT devices generally need to be identified and authenticated to operate in a network or ecosystem, and in many circumstances, the IoT devices require strong security and privacy controls. Security and privacy concerns have long plagued the Internet. Increased mobile device usage has increased these security and privacy concerns, and the advent IoT devices has heightened security and privacy concerns even further. Accordingly, the present disclosure relates to secure and private identification and certification for networked devices.

The claimed subject matter is not limited to embodiments that solve any disadvantages or that operate only in environments such as those described above. This background is only provided to illustrate examples of where the present disclosure may be utilized.

### SUMMARY

The present disclosure generally relates to identifying and authenticating certificates for networked “smart” devices. In particular, the present disclosure describes a system and method to certify and identify devices in a cryptographically safe manner.

In one example, a method may include generating a whitelist at a whitelisting authority, adding the whitelist to a PKI smart contract, adding one or more signing keys to the PKI smart contract, provisioning a device with a keypair by a manufacturer, sending a challenge to the device from a user, receiving a reply from the device at the user, and verifying a certificate and revocation status for the device by the user. The reply may include a challenge signature. The certificate and revocation status may be verified by the user using the PKI smart contract.

The method may include determining a list of manufacturers and/or devices that are to be included in the whitelist. The method may include transmitting the whitelist to the PKI smart contract from the whitelisting authority. The user may include a device associated with the user. The manufacturer may include a device associated with the manufacturer.

In another example, a method may include whitelisting a manufacturer by a whitelisting authority in response to a request by the manufacturer to be whitelisted, and adding one or more signing keys for the manufacturer's devices. Each of the signing keys may correspond to a device manufactured by the manufacturer.

The method may include verifying the identity of the manufacturer prior to whitelisting the manufacturer. The method may include including the manufacturer in a list of manufacturers determined by the whitelisting authority. The method may include transmitting the whitelisted manufacturer to a PKI smart contract. The method may include transmitting the signing keys to a PKI smart contract. In some aspects, the signing keys may be valid for a specific length of time. The signing keys may be configured to be renewed in order to be considered valid for a longer time.

In yet another example, a method may include generating a public/private keypair for a new device produced by a manufacturer and saving the public/private keypair for the new device produced by the manufacturer. The public/private keypair may be generated by the manufacturer. The method may be performed by the manufacturer to certify new devices produced by the manufacturer. The public/private keypair may be fused in the hardware or saved in memory of the device. The public/private keypair may be saved with one of the manufacturer's registered keys.

Another example method may include generating a random challenge, transmitting the challenge from a user to a device, receiving a reply to the challenge at the user from the device, verifying a signature of the reply received from the device, and verifying a certificate of the reply received from the device. The challenge may be generated by a user. The method may be performed to verify a device's certificate. The challenge may be generated by the user to determine whether the device is properly identifying itself and is associated with a correct manufacturer. The challenge may be a suite of randomly selected bytes.

The method may include receiving the challenge at the device, generating a reply at the device, and transmitting the reply from the device to the user. The method may include signing the challenge before transmitting the reply. Verifying the signature may include checking that a public key of the reply matches the challenge. Verifying the signature may include verifying that the certificate was signed by a manufacturer's non-revoked keys. Verifying the signature may include verifying that a public key was not blacklisted by a manufacturer. Verifying the signature may include verifying that a manufacturer's subscription is valid. Verifying the signature may include verifying that the device's identify is covered by a manufacturer's namespace. The method may include determining that the certificate is valid and verified.

In yet another example, a method may include generating a revocation for a manufacturer at a whitelisting authority, signing the revocation by the whitelisting authority; and transmitting the revocation to a public ledger. The revocation may include the manufacturer's public key. The method may include generating the manufacturer's certificate revocation. The public ledger may be a PKI smart contract.

In a further example, a method may include generating a revocation for a device at a manufacturer, signing the revocation by the manufacturer, and transmitting the revocation to a public ledger. In some aspects, the revocation may include the device's public key. The method may include generating the device's certificate revocation. The public ledger may be a PKI smart contract.

This Summary introduces a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

FIG. 1 illustrates an example network architecture.

FIG. 2 is a schematic diagram of an example of a system 200 for provisioning and authenticating certificates for IoT devices in a cryptographically safe manner.

FIGS. 3-5 and 6A-6B are flow diagrams of example methods to securely identify and authenticate networked devices.

FIG. 7 is a diagrammatic representation of a machine in the example form of a computing device within which a set of instructions, for causing the machine to perform any one or more of the methods discussed herein, may be executed.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

As the number of Internet of Things (IoT) devices increases, security and privacy concerns associated with these devices also increases, especially as IoT devices expand more and more, for example, in commercial and industrial applications.

Generally, for IoT devices to operate as part of a network or ecosystem, they need to be identified and authenticated. Identification is the act or process of indicating a device's identity. Authentication is the act or process of verifying that identity, or proving an indication of a device's identity. It may be important to identify and authenticate devices in a cryptographically safe manner.

In general, devices connected via the Internet use certificates to authenticate servers using the Transport Layer Security (TLS) protocol, which is a protocol designed to provide communications security over a computer network. The certificates are cryptographically secure and issued by certificate authorities which sign the certificates. Versions of the protocols are used in applications such as web browsing, email, instant messaging, and voice over IP (VoIP). Websites may use TLS to secure communications between their servers and web browsers.

However, the use of TLS for authentication is associated with various issues. For instance, web browsers need to manually trust some root certificates, and in some circumstances web browsers include a local database of accepted certificates. In addition, it is very difficult to revoke a compromised certificate, in most cases this will involve blacklisting the certificate or requiring the browsers to remove it from their local databases. However, there may be delays associated with revoking a certificate, and in the meantime many browsers will continue to access compromised websites. Further, the TLS protocol is inherently compromised by the entities controlling root authorities and thus giving those entities the ability to issue any certificate, thereby allowing man in the middle attacks. The root authorities have to be trusted to not double issue certificates for a same domain name to two distinct parties or to perform some verifications before issuing the certificates. This may be an issue for IoT devices because the device manufacturer or network operator may not have control of the root authorities, and therefore they do not have the ability to guarantee security for their devices.

For these reasons, the TLS protocol is not well-suited for authenticating IoT devices in a network or ecosystem, and some IoT device manufacturers have implemented alternatives for authentication.

For example, some IoT device manufacturers implement centralized cryptographic verification and authentication schemes. In such configurations, the IoT devices include a chip to generate a cryptographic attestation using a fused-when-manufactured key that then has to be verified by the manufacturer's servers. However, this alternative solution still requires a trusted central entity (in this case, the manufacturer) and introduces one single point of failure that may still be compromised to certify fake devices or if the server is simply made unavailable the verification of devices becomes impossible.

Another alternative to TLS authentication is blockchain-based authentication schemes. In such configurations, every certificate or identifier is issued, stored and verified on a public blockchain ledger. This approach addresses some of the concerns described above, but it is also associated with downsides that make it unsuitable for IoT device networks. In particular, every identity is saved on a blockchain, which means that each time a certificate needs to be issued (for example, for a newly manufactured device) a transaction needs to be created and processed. For the transaction to be processed the associated computing resources need to be paid for, and therefore the device manufacturer would need to pay to issue a certificate for each new device that is manufactured. In some circumstances, certificate generation may be bundled together for many devices and storage of the complete certificates may be offloaded to a network such as the InterPlanetary File System (IPFS) which is a peer-to-peer hypermedia protocol. However, these solutions do not address concerns such as saturation of the blockchain network, and fees to create new certificates for every new device that is manufactured. Further, if an IoT device manufacturer has to save all of its devices' certificates on a public blockchain, it becomes possible for competitors and analysts to determine information regarding how many devices are manufactured.

Accordingly, the present disclosure describes systems and methods for provisioning and authenticating certificates for IoT devices. In particular, the present disclosure describes systems and methods to certify and identify devices in a cryptographically safe manner, without the issues associated with blockchain-based authentication, centralized cryptographic authentication, TLS authentication and other authentication schemes.

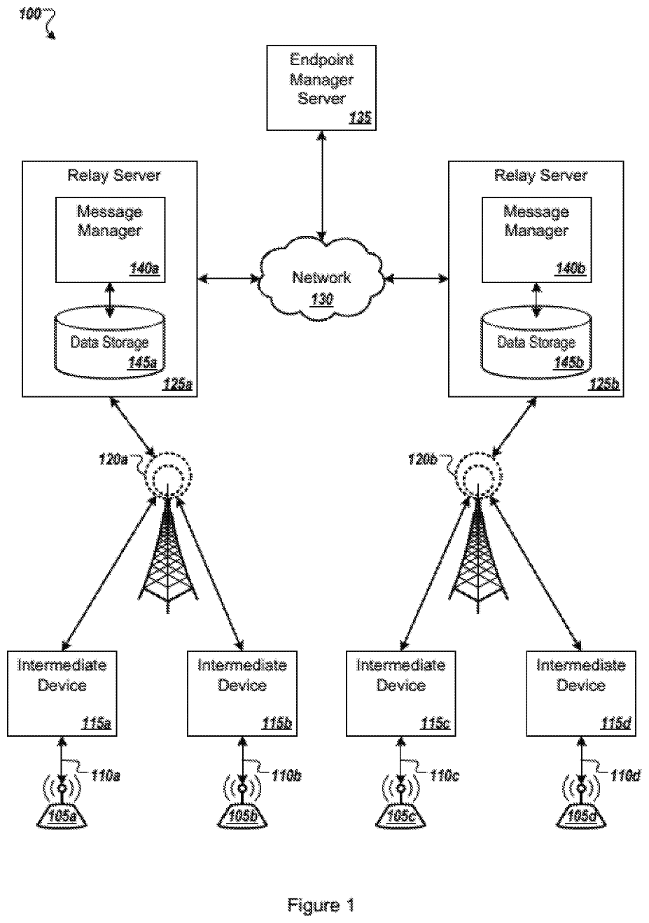

FIG. 1 illustrates an example network architecture 100 in which embodiments of the present disclosure may be implemented. The network architecture 100 may include one or more endpoint devices 105, one or more intermediate devices 115, one or more relay servers 125, and one or more endpoint manager servers 135. In some embodiments, the network architecture 100 may be capable to move data between one or more endpoint devices 105 and various endpoint manager servers 135 by way of crowd-sourced intermediate devices 115, which may function as network clients, and one or more relay servers 125.

An endpoint device 105 may include one or more IoT devices. The endpoint device 105 may include a power supply, a data collection device (e.g., a sensor), and a network device. The power supply may include a battery or a connection to a power grid. Additionally or alternatively, the power supply may include an energy harvesting apparatus, such as a solar panel, solar cell, solar photovoltaic, electromagnetic, etc. In at least some embodiments, the endpoint device 105 may not include a power supply and may instead use ambient backscatter techniques. The endpoint device 105 may also include one or more sensors. The one or more sensors may be configured to detect any type of condition, and generate electronic data based on a detected condition. For example, the endpoint device 105 may include a smart watch with a heart rate monitor that is configured to generate heart rate data using heart rate conditions collected by the heart rate monitor. In some embodiments, the endpoint device 105 does not have capability to communicate over the Internet and only includes hardware and/or software capable of communicating with nearby devices, such as a nearby intermediate device 115. In other embodiments, the endpoint device 105 may include hardware and/or software communicate over the Internet.

The network device of the endpoint device 105 may include any hardware, software, or combination thereof that is capable to communicate with another device via a network. In at least one embodiment, the network device may include any network controller configured to communicate via a short-range network, such as Bluetooth® or any other short-range network. In at least one embodiment, the network device may include any network controller configured to communicate via a low-power network. Example endpoint devices 105 include, but are not limited to, industrial devices, residential appliances, commercial equipment, inventory trackers, smart watches, wearables, heart rate monitors, logistics trackers, environmental sensors, cash registers, credit card readers, point-of-sale (POS), bikes, electric scooters, electric skateboards, cars, electric cars, satellites, or any device (mobile and not mobile that includes a wireless radio interface. The network architecture 100 may include any number of endpoint devices 105 and the endpoint devices 105 in the network architecture 100 may be any type of endpoint device 105, including any type of network-capable device. The endpoint devices 105 may be fixed or relatively stationary in the network architecture 100, such as a POS or a pollution sensor. Additionally or alternatively, the endpoint devices 105 may be mobile, such as a smart watch, or any car or vehicle.

The one or more endpoint devices 105 may be configured to communicate with other devices via at least one wireless network 110. For example, a first endpoint device 105a may be in electronic communication with a first intermediate device 115a via a wireless network 110a. The one or more intermediate devices 115 may include any type of device capable of communicating with an endpoint device 105 via the wireless network 110 and with a relay server 125 via a second network 120. In at least one embodiment, an intermediate device 115 may include two network controllers—a first network controller to communicate via the wireless network 110 and a second network controller to communicate via the second network 120. Example intermediate devices 115 include mobile devices, personal computers (PC), laptops, smart phones, netbooks, e-readers, personal digital assistants (PDA), cellular phones, mobile phones, tablets, vehicles, drones, cars, trucks, wearable devices, routers, televisions, or set top boxes, etc.

As illustrated, the first endpoint device 105a may be in electronic communication with the first intermediate device 115a via the wireless network 110a (e.g., a short-range network). Further, a second endpoint device 105b may be in electronic communication with a second intermediate device 115b via another wireless network 110b (e.g., a low-power network). A third endpoint device 105c may be in electronic communication with a third intermediate device 115c via another wireless network 110c. A fourth endpoint device 105d may be in electronic communication with a fourth intermediate device 115d via another wireless network 110d.

In some embodiments, the wireless network 110 may be any network that uses a relatively low amount of power. Example wireless networks 110 may include any Bluetooth® network type (e.g., Bluetooth Low Energy (BLE), Bluetooth 4.0, Bluetooth 5.0, Bluetooth Long Range), NB-IoT, LTE Direct, LTE-M, LTE M2M, 5G, Wi-Fi, Wi-Fi Aware or any low-power network. The one or more endpoint devices 105 may connect to various intermediate devices 115 using different types of wireless networks 110. For example, the first endpoint device 105a may be in electronic communication with the first intermediate device 115a via a first short-range wireless network 110a and the second endpoint device 105b may be in electronic communication with the second intermediate device 115b via a second short-range wireless network 110b.

Endpoint devices 105, intermediate devices 115, or both, may be fixed, relatively stationary or moveable. When an endpoint device 105 and an intermediate device 115 come into wireless range of each other, the endpoint device 105 and the intermediate device 115 may perform a handshake and/or authentication to initiate data exchange between the endpoint device 105 and the intermediate device 115.

In some embodiments, the endpoint device 105 may periodically send beacons that include data via the wireless network 110. The endpoint devices 105 may include various services that may run on the endpoint devices 105. For example, a smart watch may include a clock service, a heart rate monitor service, a motion detection service, a music service, etc. Beacons may be generated for each of these services or a single beacon may be generated to include data for some or all of the services.

An intermediate device 115 may listen for such beacons from endpoint devices. Responsive to receiving a beacon, the intermediate device 115 may send the beacon to a relay server 125 via a second network 120. In at least one embodiment, the wireless network 110 and the second network 120 are different types of networks. For example, the wireless network 110 may be a Bluetooth® network and the second network 120 may be a cellular network, Wi-Fi, or the Internet.

The second network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof.

The relay server 125 may send the beacon, or information related to the beacon, to an endpoint manager server 135 via a third network 130. The third network 130 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof. In at least one embodiment, the second network 120 and the third network 130 are the same network or include at least some overlapping components.

The one or more relay servers 125 may include one or more computing devices, such as a rackmount server, a router computer, a server computer, a personal computer, a mainframe computer, a laptop computer, a tablet computer, a desktop computer, smartphone, cars, drones, a robot, any mobility device that has an operating system, etc.), data stores (e.g., hard disks, memories, databases), networks, software components, and/or hardware components. The one or more relay servers 125 may be configured to receive a beacon from an intermediate device 115. The one or more relay servers 125 may send the beacon, or data related to or associated with to an endpoint manager server 135. The one or more relay servers 125 may receive a message from the endpoint manager server 135 and, in some embodiments, may send the message from the endpoint manager server 135 to an intermediate device 115. In at least some embodiments, the intermediate device 115 may perform one or more operations responsive to receiving the message from the endpoint manager server 135. The operations include operations local to the intermediate device 115, and/or sending the message from the endpoint manager server 135 to an endpoint device 105.

The endpoint manager server 135 may include one or more computing devices, such as a rackmount server, a router computer, a server computer, a personal computer, a mainframe computer, a laptop computer, a tablet computer, a desktop computer, a smartphone, a car, a drone, a robot, any mobility device that has an operating system etc.), data stores (e.g., hard disks, memories, databases), networks, software components, and/or hardware components. The endpoint manager server 135 may be associated with one or more endpoint devices 105. For example, a particular corporation, person, or manufacturer may sell an endpoint device 105 and may use an endpoint manager server 135 to communicate with and/or control the endpoint device 105.

The endpoint manager server 135 may send messages associated with a particular endpoint device 105, or a set of endpoint devices 105. For example, the endpoint manager server 135 may send updates (e.g., firmware, software) to the particular endpoint device 105, or the set of endpoint devices 105. The endpoint manager server 135 may send other communications to an endpoint device 105, such as a response to a request from a beacon generated by the particular endpoint device 105.

Each relay server 125 may include a message manager 140. The message manager 140 may be implemented using hardware including a processor, a microprocessor (e.g., to perform or control performance of one or more operations), an FPGA, or an ASIC. In some other instances, the message manager 140 may be implemented using a combination of hardware and software. Implementation in software may include rapid activation and deactivation of one or more transistors or transistor elements such as may be included in the hardware of a computing system (e.g., the relay server 135). Additionally, software defined instructions may operate on information within transistor elements. Implementation of software instructions may at least temporarily reconfigure electronic pathways and transform computing hardware.

Each relay server 125 may include a data storage 145. The data storage 145 may include any memory or data storage. In some embodiments, the data storage 145 may include computer-readable storage media for carrying or having computer-executable instructions or data structures stored thereon. The computer-readable storage media may include any available media that may be accessed by a general-purpose or special-purpose computer, such as a processor. For example, the data storage 145 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145. In the depicted embodiment, the data storage 145 is part of the relay server 125. In some embodiments, the data storage 145 may be separate from the relay server 125 and may access the data storage 145 via a network. In at least one embodiment, the data storage 145 may include multiple data storages.

The data storage 145 may include data pertaining to the endpoint devices 105, intermediate devices 115, and endpoint manager servers 135 and relationships between the endpoint devices 105, intermediate devices 115, and endpoint manager servers 135. For example, the data storage 145 may include a table or list of endpoint devices that are associated with a particular endpoint manager server 135. The data storage 145 may include data pertaining to beacons received from endpoint devices, such as a timestamp of the receipt of the beacon, a timestamp associated with the creation of the beacon, a geo-location associated with the beacon and/or the endpoint device 105 that created or transmitted the beacon, sensor data associated with the endpoint device, routing information for how and/or where to send data between endpoint manager servers 135 and endpoint devices 105, connection strengths between intermediate devices and endpoint devices, proximity of an endpoint device 105 to an intermediate device 115, type of wireless network 110 that connects an intermediate device 115 and an endpoint device 105, a cost of a connection between an intermediate device 115 and an endpoint device 105, a current battery level of the intermediate device, a type of intermediate device, etc.

The message manager 140 may process communications between the endpoint devices 105, the intermediate devices 115 and the endpoint manager server(s) 135. In an example, the message manager 140 may receive a beacon from the intermediate device 115a via the second network 120a. The beacon may have been sent to the intermediate device via the wireless network 110a by endpoint device 105a. A beacon may contain characteristics about the endpoint device 105, including an identifier of the endpoint device 105 (e.g., a MAC address, a unique ID), a geographical location of the endpoint device 105a, and advertisements of the UUIDs of the services it supports, etc. The message manager 140 may identify the characteristics of the beacon, such as by analyzing the beacon to identify information pertaining to the beacon. The message manager 140 may access the data storage 145 to identify, based on the characteristics of the beacon, an endpoint manager server 135 that is associated with the beacon. For example, the identifier of the endpoint device may be associated with a particular manufacturer that operations a particular endpoint manager server 135. The message manager 140 may identify this particular endpoint manager server 135 in the data storage 145 and an address and/or path to send the beacon in order to reach the endpoint manager server 135. In at least some embodiments, the message manager 140 may send the beacon, or a beacon message to the endpoint manager server 135 via the third network 130. The beacon message may include the beacon, may not include the beacon, or may include information pertaining to the beacon.

In at least one embodiment, a beacon may include data from multiple services associated with the endpoint device 105. Additionally or alternatively, multiple beacons from a single endpoint device 105 may be generated and broadcast via the wireless network 110. Each of these multiple beacons, for example, may be associated with a different service associated with the endpoint device 105. The message manager 140 may identify the services, and based on information for the service, identify an appropriate endpoint manager server 135 that should receive a beacon message.

The endpoint manager server 135 may receive the message from the relay server 125. The endpoint manager server 135 may store the message, process the message, generate a report based on the message, may generate a notification or response based on the message, or any other action. For example, endpoint manager server 135 may generate a response message pertaining to the beacon message. The response message may include a message intended for one or more of the relay server 125, an intermediate device 115, the endpoint device 105 that generated the beacon, or another endpoint device 105 that did not generate the beacon. The endpoint manager server 135 may send the response message to the same relay server 125 that sent the beacon message to the endpoint manager server 135 (e.g., the relay server 125a), or to a different relay server 125 that did not send the beacon message to the endpoint manager server 135 (e.g., relay server 125b).

The relay server 125 may receive, from the endpoint manager server 135, the response message pertaining to the beacon message. The relay server 125 may process the response message, such as by performing operations at the relay server 125, sending data to another device (e.g., a user device), sending data to an endpoint device 105, etc.

The network architecture 100 may be used to exchange data between any devices capable of network-based communication in a manner that is different than conventional communication over the Internet.

In an example, the network architecture 100 may leverage existing smartphone infrastructure to create delay-tolerant connectivity. The network architecture 100 can move data to the cloud in an initially delay tolerant fashion, which may be useful for many types of IoT communications such as firmware updates, status updates, log-file storage, and micropayments. The intermediate device may include software that runs on smartphones to periodically scan for other devices (e.g., the endpoint devices 105) like industrial devices, smartwatches, wearables, logistics trackers, and environmental sensors. These endpoint devices 105 may connect with the software client running on the smartphones to create massive, area wide networks for moving data to and within the cloud.

Further, it has been estimated that 95% of the human population is covered by some sort of cellular service. The network architecture 100 can be deployed anywhere in the world and enables regions of lower connectivity to increase their connectivity. Moreover, the network architecture 100 can provide coverage beyond the reach of conventional cellular networks by using software that runs on Bluetooth®-enabled smartphones, for example. Users may travel to areas of limited or no cellular connectivity, but still may receive beacons from endpoint devices 105 via the wireless network 110. Using the network architecture 100, telco operators, for example, can now easily deploy a software update to their user devices to begin communicating with endpoint devices 105 as described herein to provide higher latency IoT connectivity to even the remotest regions of the world.

In a specific example, the network architecture 100 can be used for asset tracking and management. For example, the network architecture 100 can be used to find lost items that are configured as an endpoint device 105, such as a skateboard with a wireless radio chipset, an attached tracking beacon, a laptop, etc. A user, for example, may indicate that the item is lost, such as by using a mobile application or website to indicate, to the endpoint manager server 135 or to the relay server 125, that the item is lost. In a first embodiment, the endpoint manager server 135 may send a message to one or more relay servers 125 to watch for the lost item. The relay servers 125 may add an identifier of the lost item to a lost item watch list. As intermediate devices 115 move to different geographic locations, they can receive beacons from different endpoint devices 103. The intermediate devices 115 then forward the beacons to the relay servers 125. When a relay server 125 server receivers a beacon, the relay server 125 can analyze the beacon to determine if the beacon originated at an endpoint device 105 that is on the watch list. When the relay server 125 identifies a beacon that originated at an endpoint device 105 that is on the watch list, the relay server 125 can notify the endpoint manager server 135 that the lost item has been found. In at least some embodiments, the relay server 125 may send the notification that the lost item has been found as a push notification or as a pull notification (i.e., in response to a request from the endpoint manager server 135). In at least some embodiments, the relay server 125 may send the notification that the lost item has been found to the user device that was used by the user to indicate that the item was lost.

As the intermediate devices 115 and/or the endpoint devices 105 move to different geographic locations, the manner they communicate in the network architecture 100 may change. For example, if one of the endpoint devices 105 moves to a location where it is no longer close enough to one of the intermediate devices 115 to be able to communicate with it, then it may continue to send beacons even though there is no device within range to receive the beacons. Furthermore, the endpoint devices 105 may continue to send beacons until one of the intermediate devices 115 is within range. Similarly, the intermediate devices 115 may move to locations out of a range of the endpoint devices 105, and the network architecture 100 may adapt accordingly.

The network architecture 100 may select one of the intermediate devices 115 to communicate and/or forward beacons for a corresponding one of the endpoint devices 105. For example, one of the relay servers 125 may select one of the intermediate devices 115 to handle sending the response message to one of the endpoint devices 105. The relay server 125 may use any selection criteria to select which intermediate device 115 to use to send the response message, such as a connection strength between the intermediate device 115 and the target endpoint device 105, a proximity of an endpoint device 105 to an intermediate device 115, a type of wireless network 110 that connects an intermediate device 115 and an endpoint device 105, a cost of a connection between an intermediate device 115 and an endpoint device 105, a current battery level of the intermediate device, a type of intermediate device, etc.

In some circumstances, two of the intermediate devices 115b may be within range of one of the endpoint devices 105 and both may receive the same beacon from the endpoint device 105. Further, both of the intermediate devices 115 may forward the beacon of the endpoint device 105 to one of the relay servers 125. To reduce redundancy, network traffic, battery impact, etc., the relay server 125 may select one of the intermediate devices 115 and the intermediate devices 115 to handle communication with the endpoint device 105 and instruct the non-selected intermediate device to ignore beacons from the endpoint device 105, to discard beacons from the endpoint device 105, to stop sending beacons from the endpoint device 105, or any other operation that may reduce network congestion, free-up data storage space, free-up processor capabilities, etc.

As more intermediate devices 115 become available for data transport, data transmission frequency for a particular intermediate device 115 may decrease. In the long term, with enhanced density intermediate device 115 and machine learning based protocols, the technology described here may significantly improve battery life for intermediate devices 115, reduce network congestion, improve global connectivity, etc. The relay server 125 may use any selection criteria to select which intermediate device 105 to use to communicate with the endpoint device 105 and which intermediate device 115 to cease communications regarding the endpoint device 105, such as a connection strength between the intermediate device 115 and the target endpoint device 105, a proximity of the endpoint device 105 to the intermediate device 115, a type of wireless network 110 that connects the intermediate device 115 and the endpoint device 105, a cost of a connection between the intermediate device 115 and the endpoint device 105, a current battery level of the intermediate device 115, a type of intermediate device 115, etc.

Modifications, additions, or omissions may be made to the network architecture 100 without departing from the scope of the present disclosure. The present disclosure more generally applies to the network architecture 100 including one or more endpoint devices 105, one or more wireless networks, one or more intermediate devices 115, one or more second networks 120, one or more relay servers 125, one or more third networks 130, and one or more endpoint manager servers 135 or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

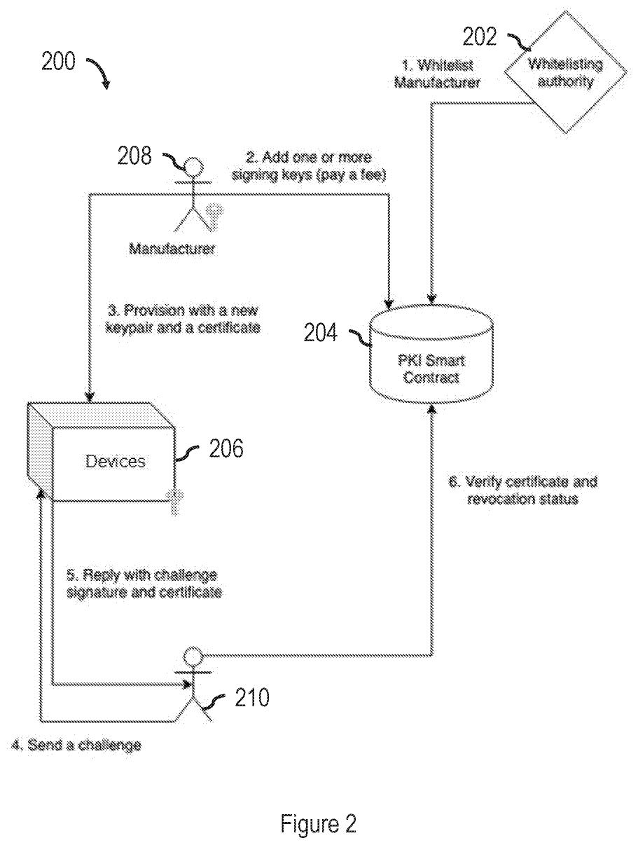

FIG. 2 is a schematic diagram of an example of a system 200 for provisioning and authenticating certificates for IoT devices in a cryptographically safe manner. In some aspects, the system 200 may include a blockchain public key infrastructure (PKI). A public key infrastructure (PKI) may include a set of roles, policies, hardware, software and procedures needed to create, manage, distribute, use, store and revoke digital certificates and manage public-key encryption. The system 200 may include a set of roles, policies, hardware, software and procedures needed to create, manage, distribute, use, store and revoke digital certificates and manage public-key encryption. The system 200 may be used to provision and authenticate certificates for any suitable devices, such as the endpoint devices 105 of FIG. 1. Further, system 200 may be used to provision and authenticate certificates for other devices, such as the intermediate devices 115 and/or the relay servers 125. In other aspects, the system 200 may be used to provision and authenticate certificates for websites or any suitable authentication schemes.

As illustrated, the system 200 may include a whitelisting authority 202, a PKI smart contract 204, and one or more devices 206. The system 208 may be used by one or more manufacturers 208 that want to authenticate (e.g., certify) the identity of their devices 206. In particular, the manufacturers 208 may authenticate the identity of the devices 206 they manufacture. Users 210 may use the system 200 to verify a certificate of the devices 206 for authentication. In some circumstances, the users 210 and/or the manufacturers 208 may be part of the system 200. As used herein, the users 210 and/or the manufacturers 208 may refer to devices and/or systems associated with the users 210 and the manufacturers 208, respectively.

In some configurations, the whitelisting authority 202 may be a network operator for IoT devices, such as the devices 206. In such configurations, the whitelisting authority 202 may determine or set a list of manufacturers and/or devices that are to be whitelisted or permitted to be identified and authenticated. In other configurations, the whitelisting authority 202 may be a decentralized decision scheme for determining a whitelist, including determining a list of devices that are to be whitelisted, or permitted to be identified and authenticated.

The devices 206 may have a cryptographic identity which may be certified by their manufacturer 208. In one example, the cryptographic identity may be device.manufacturer.iot. The manufacturer 208 may have a manufacturer identity. The manufacture identity may be an umbrella or characterization for all devices manufactured by this specific manufacturer. In one example, the cryptographic identity may be manufacturer.iot.

The whitelisting authority 202 may verify and/or authenticate the applications of the manufacturer 208, for example, to prevent an undesired third party from getting a certificate. In some configurations, the whitelisting authority 202 may implement a Know Your Customer (KYC) process to identify and verify the identity of its customers, in this case, the manufacturer 208. The KYC process may include steps taken by the whitelisting authority 202 to establish and/or verify the identity of the manufacturer 208.

The issued certificates may only allow the manufacturer 208 to sign an identity whose scope is limited to that specific manufacturer. For example, the manufacturer 208 may only be permitted to sign an identity of *.manufacturer.iot, wherein * is a placeholder for an identity of a device which is manufactured by the manufacturer (or any device manufactured by the specific manufacturer). Accordingly, the issued certificates may only allow the manufacturer to sign an identity for devices that were manufactured by the manufacturer. In at least one embodiment, the certificate may be stored on a Hardware Security Module (HSM). A HSM may include a physical computing device that safeguards and manages digital keys, performs encryption and decryption functions for digital signatures, strong authentication and other cryptographic functions.

The PKI smart contract 204 may be a database or storage medium that includes the whitelist determined by the whitelisting authority 202. In some configurations, the PKI smart contract 204 may be a public registry. The whitelisting authority 202 or network operator may be able to add or ban manufacturers in the PKI smart contract 204. The manufacturer 208 may be able to add or revoke public signing keys in the PKI smart contract 204. Furthermore, the manufacturer 208 may be able to revoke a device's keys for specific devices if needed, for example, in case the device is hacked or compromised. In addition, the manufacturer 208 may be able to associate an expiration date with their public keys. In such circumstances, the public keys may be automatically revoked after the expiration date.

A method of authenticating devices using the system 200 may include the whitelisting authority 202 generating a whitelist. The whitelisting authority 202 may determine or set a list of manufacturers and/or devices that are to be included in the whitelist. The whitelist may be added to the PKI smart contract 204. In some configurations, the whitelist may be transmitted to the PKI smart contract 204 by the whitelisting authority 202, which may be communicatively coupled to one another.

The method may include the manufacturer 208 adding one or more signing keys to the PKI smart contract 204. In some configurations, the signing keys may be transmitted to the PKI smart contract 204 by the manufacturer 208, which may be communicatively coupled to one another. In some circumstances, adding one or more signing keys to the PKI smart contract 204 may include paying a fee to the whitelisting authority 202 and/or network operator.

The method may include the manufacturer 208 provisioning the device 206 with a keypair and/or a certificate. In some configurations, the keypair and/or a certificate may be transmitted to the device 206 by the manufacturer 208, which may be communicatively coupled to one another. In other configurations, the keypair and/or a certificate may be included with the device 206 when the device 206 is manufactured by the manufacturer 208.

The method may include the user 210 sending a challenge to the device 206. In some configurations, the challenge may be transmitted to the device 206 by the user 210, which may be communicatively coupled to one another. Upon receiving the challenge, the device 206 may reply to the user 210. The reply may include a challenge signature and/or certificate. In some configurations, the reply may be transmitted to the user 210 by the device 206. The method may include the user 210 verifying certificate and revocation status with the PKI smart contract 204. In some configurations, the certificate verification and revocation status may be transmitted between the user 210 and the PKI smart contract 204, which may be communicatively coupled to one another.

Methods of authenticating devices, for example, using the system 200, will be described in further detail below.

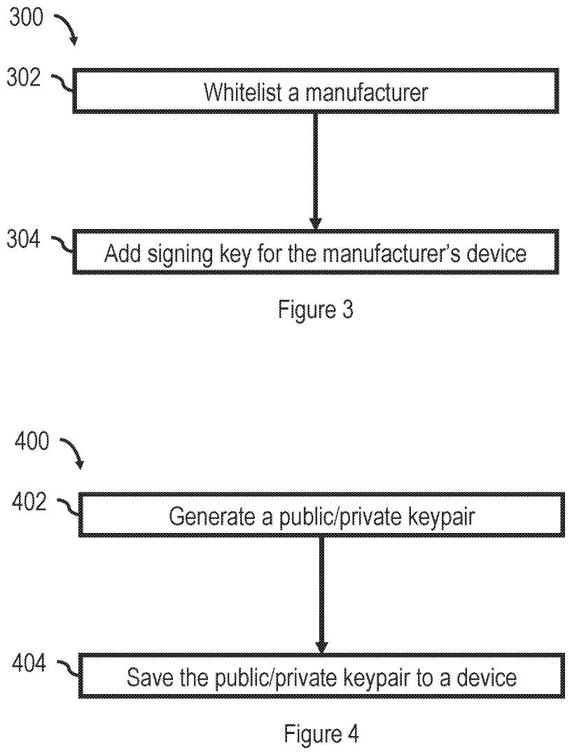

FIGS. 3-5 and 6A-6B are flow diagrams of example methods to securely and privately identify and certify networked devices. The methods described may be used to provision and authenticate certificates for networked IoT devices in a cryptographically safe manner.

The methods may be performed by processing logic that may include hardware (circuitry, dedicated logic, etc.), software (such as is run on a general purpose computer system or a dedicated machine), or a combination of both, which processing logic may be included in the endpoint devices 105, intermediate device 115, the relay server 125, and/or the endpoint manager server 135 of FIG. 1, or another computer system or device. However, another system, or combination of systems, may be used to perform the methods.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 is a flow diagram of an example method 300 to obtain a signing key. For example, the method 300 may be performed by the manufacturer 208 and/or the whitelisting authority 202 of FIG. 2 to obtain a signing key. The method 300 may be performed to obtain signing keys for devices in the system 200 and/or the network architecture 100.

The method 300 may begin at block 302, wherein a manufacturer may be whitelisted. In some configurations, the manufacturer may be whitelisted by a whitelisting authority or network operator, such as the whitelisting authority 202 of FIG. 2. The manufacturer may be whitelisted in response to a request by manufacturer to be whitelisted. The manufacturer may be whitelisted after verification to prevent an undesired third party from being whitelisted. In some configurations, a KYC process may be implemented to identify and verify the identity of the manufacturer before the manufacturer is whitelisted. The KYC process may include steps taken by the whitelisting authority to establish and/or verify the identity of the manufacturer. In further configurations, the manufacturer may be whitelisted in response to executing a contract with the whitelisting authority or network operator. The manufacturer may be included in a list of manufacturers determined by the whitelisting authority. The identity of the whitelisted manufacturer may be transmitted to a PKI smart contract, such as the PKI smart contract 204 of FIG. 2.

At block 304, one or more signing keys may be added for the manufacturer's devices. In some configurations, the signing keys may be added by the manufacturer. Each of the signing keys may correspond to a device manufactured by the manufacturer. In some circumstances, payments may be made for each of the keys, for example, from the manufacturer to the whitelisting authority or network operator. The payment amount may depend on the validity. In some configurations, keys may be valid for a specific length of time, which may be predetermined by agreement, and/or may be renewed in order to be considered valid for a longer time. In some configurations, the signing keys may be transmitted to a PKI smart contract, such as the PKI smart contract 204 by the manufacturer.

FIG. 4 is a flow diagram of an example method 400 to certify new devices. For example, the method 400 may be performed by the manufacturer 208 to certify the devices 206 of FIG. 2. The method 400 may be performed for new devices produced by a manufacturer in the system 200 and/or the network architecture 100.

The method 400 may begin at block 402, wherein a public/private keypair may be generated. The public/private keypair may be generated by the manufacturer. The manufacturer may provision a newly produced device with the public/private keypair. Accordingly, the public/private keypair may be generated for a new device produced by the manufacturer.

At block 404, the public/private keypair may be saved to a device. For example, the public/private keypair may be fused in the hardware or saved in memory of the device. Accordingly, the public/private keypair may be included with the device when the device is manufactured by the manufacturer. In another example, the public/private keypair may be transmitted to the device by the manufacturer, which may be communicatively coupled to one another. The signature of the device's public key may be saved with one of the manufacturer's registered keys, for example, with the signing key obtained according to method 300. Accordingly, saving the public/private keypair may include saving the signing key of the manufacturer along with the public/private keypair.

After the new device is certified and the public/private keypair is saved along with the device, the device may be shipped, for example, to a customer via distribution network.

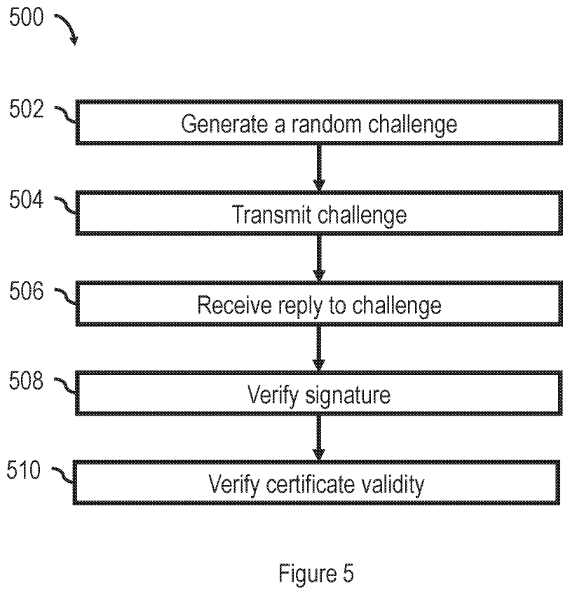

FIG. 5 is a flow diagram of an example method 500 to verify a device's certificate. For example, the method 500 may be performed to verify a certificate of the device 206 of FIG. 2. The method 500 may be performed for devices used in the system 200 and/or the network architecture 100.

The method 500 may involve a manufacturer (such as the manufacturer 208 of FIG. 2), an IoT device (such as the device 206 of FIG. 2), and a user (such as the user 210 of FIG. 2). For the purposes of this description, Ivan denotes the manufacturer, Alice denotes the IoT device and Bob denotes the user.

The device (Alice) may claim it is associated with the manufacturer (Ivan) and the user (Bob) may want to verify that the device is properly identifying itself and is actually associated with the manufacturer. The device (Alice) may have an identity, a private key and an associated public key. The identity may be A_{id} (alice.ivan.iot), the private key may be Aₚᵣᵢᵥ and the public key may be A_{pub}.

The manufacturer (Ivan) may have an identify, a keypair and may produce a certificate for the device (Alice). The identity may be ivan.iot, the keypair may be Iₚᵣᵢᵥ, I_{pub}, and the produced certificate may be Cert=A_{pub}, A_{id}, Iₚᵣᵢᵥ(Hash(A_{pub}+A_{id})).

The manufacturer (Ivan) may have manufactured the device (Alice), and may have embedded or included the device identity, private key, public key and/or the certificate at the time of manufacture or thereafter. Accordingly, the manufacturer (Ivan) may have embedded the following in the device (Alice) upon manufacture: A_{id}, A_{pub}, Aₚᵣᵢᵥ, Cert.

The method 500 may begin at block 502, wherein a random challenge may be generated. The challenge may be generated by the user (Bob) to identify or authenticate a device, that is, to determine whether a device (Alice) is properly identifying itself and is actually associated with a correct manufacturer (Ivan). The challenge may be represented by $$c$$. In some configurations, the challenge may be a suite of randomly selected bytes of any size.

At block 504, the challenge may be transmitted. For example, the challenge may be sent from the user (Bob) to the device (Alice), which may be communicatively coupled to one another. Thus, the challenge c may be transmitted from the user (Bob) to the device (Alice).

In response to receive the challenge, the device (Alice) may sign the challenge and reply to the challenge. The reply may be sent from the device (Alice) to the user (Bob). The device (Alice) signature of the challenge may be represented by A_{sig}=Aₚᵣᵢᵥ(Hash(c)) and the reply may be represented by (A_{sig}, Cert).

At block 506, the reply to the challenge may be received. In particular, the user (Bob) may receive the reply to the challenge from the device (Alice). Thus, the user (Bob) may receive (A_{sig},Cert) from the device (Alice).

At block 506, the signature may be verified. In particular, the user (Bob) may verify the signature received with the reply to the challenge from the device (Alice). The user (Bob) may verify the signature by checking that the public key matches the challenge. The user (Bob) may verify the signature A_{sig} by checking that A_{pub}(Hash(c)) matches c and A_{sig}.

At block 508, the validity of the certificate may be verified. In particular, the user (Bob) may verify the validity of the certificate received with the reply to the challenge from the device (Alice). Verifying that the certificate is valid may include verifying that the certificate was signed by one of the manufacturer's (Ivan) non-revoked keys. Verifying that the certificate is valid may include verifying that the public key was not blacklisted by the manufacturer (Ivan). Verifying that the certificate is valid may include verifying that the manufacturer's (Ivan) subscription is currently valid or remains valid. Verifying that the certificate is valid may include verifying that the device's (Alice) identify is covered by the manufacturer's (Ivan) namespace.

Accordingly, the user (Bob) may determine that the certificate is valid and verified in response to the certificate Cert: being signed by one of the manufacturer's (Ivan) non-revoked keys; A_{pub} being not blacklisted by the manufacturer (Ivan); the manufacturer's (Ivan) subscription being currently valid; and/or A_{id} being covered by the manufacturer's (Ivan) namespace.

Upon the certificate being valid, the device (Alice) may be certified and/or authenticated. After certification, the device (Alice) may operate within the network or ecosystem, and/or may communicate with devices that are part of the network or ecosystem.

If revoking a certificate is desired, a network operator or whitelisting authority may revoke a certificate, and the revocation may be pushed onto the blockchain. Revoking certificates, manufacturer's keys, and device keys will be described in further detail below.

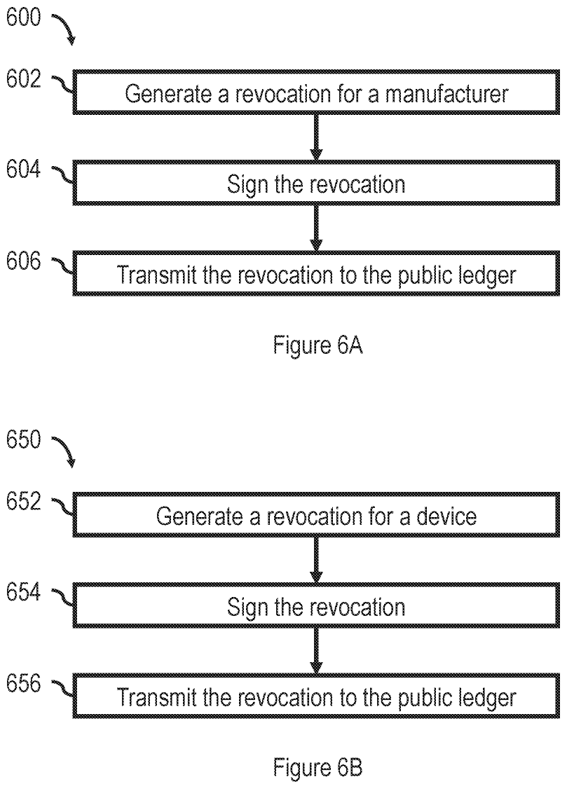

FIG. 6A is a flow diagram of an example method 600 to revoke a manufacturer's key and FIG. 6B is a flow diagram of an example method 650 to revoke a device's key. For example, the method 600 may be performed by the whitelisting authority 202 of FIG. 2 to revoke a manufacturer's key. The method 600 may be performed to revoke a certificate for manufacturers of devices in the system 200 and/or the network architecture 100. The method 600 may be performed by the manufacturer 208 of FIG. 2 to revoke a device's key. The method 650 may be performed to revoke a certificate for devices in the system 200 and/or the network architecture 100.

The method 600 may be implemented to revoke a manufacturer's public key. For example, a manufacturer may be represented by M and the manufacturer's public key may be represented by M_{pub}.

The method 600 may begin at block 602, wherein a revocation may be generated for a manufacturer. The revocation may be generated by a whitelisting authority (e.g., the whitelisting authority 202) or network operator. The revocation may include the manufacturer's public key. Accordingly, the revocation may include M's public key R_{M}=(M_{pub}).

At block 604, the revocation may be signed. In some configurations, the revocation may be signed by the whitelisting authority (e.g., the whitelisting authority 202) or network operator. The whitelisting authority or network operator may sign the revocation and generate the manufacturer's certificate revocation, which may be represented by MCR=(R_{M},Nₚᵣᵢᵥ(Hash(R_{M})).

At block 606, the revocation may be transmitted to a public ledger. In some configurations, the revocation may be transmitted to the public ledger by the whitelisting authority or network operator, which may be communicatively coupled to one another. In some configurations, the public ledger may be the PKI smart contract 204 of FIG. 2, although other configurations may be implemented. The public ledger may be implemented as a dedicated Blockchain network or take the form of a smart contract.

The method 650 may be implemented to revoke a device's public key. For example, a device may be represented by $$D$$ and the device's public key may be represented by D_{pub}.

The method 650 may begin at block 652, wherein a revocation may be generated for a device. The revocation may be generated by a manufacturer (e.g., the manufacturer 208). The revocation may include the device's public key. Accordingly, the revocation may include D's public key R_{D}=(D_{pub}).

At block 654, the revocation may be signed. In some configurations, the revocation may be signed by the manufacturer (e.g., the manufacturer 208). The manufacturer may sign the revocation and generate the device's certificate revocation, which may be represented by DCR=(R_{D}, Mₚᵣᵢᵥ(Hash(R_{D}))).

At block 656, the revocation may be transmitted to the public ledger. In some configurations, the revocation may be transmitted to the public ledger by the manufacturer, which may be communicatively coupled to one another. In some configurations, the public ledger may be the PKI smart contract 204 of FIG. 2, although other configurations may be implemented.

In some configurations, the revocations of methods 600 and 650 may be implemented free of charge by the whitelisting authority or network operator. Such configurations may avoid disincentivize fast reactions when a key is compromised.

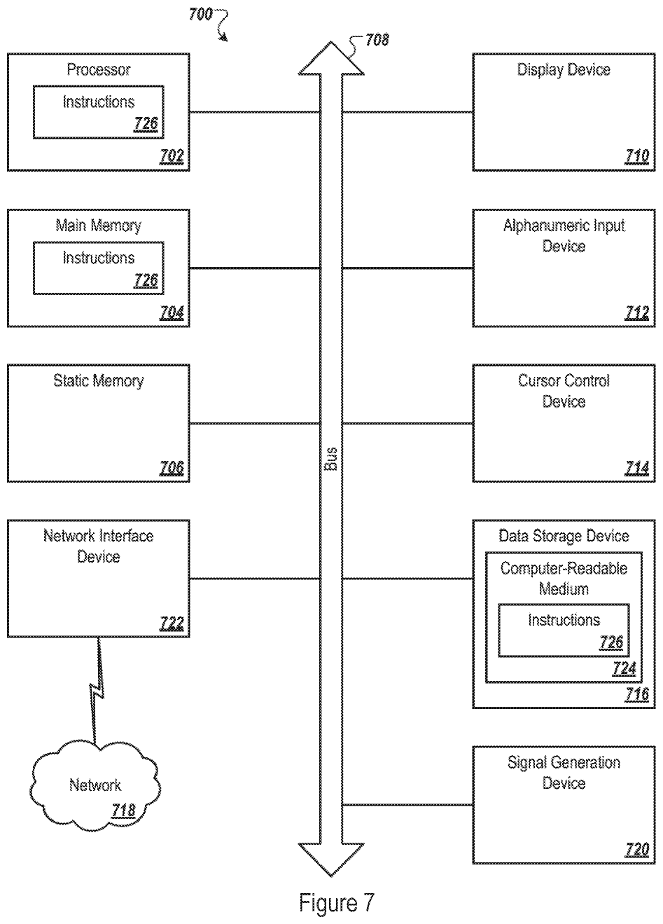

FIG. 7 illustrates a diagrammatic representation of a machine in the example form of a computing device 700 within which a set of instructions, for causing the machine to perform any one or more of the methods discussed herein, may be executed. The computing device 700 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 may also include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one embodiment, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 726 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

An example method may include whitelisting a manufacturer by a whitelisting authority in response to a request by the manufacturer to be whitelisted and adding one or more signing keys for the manufacturer's devices, each of the signing keys corresponding to a device manufactured by the manufacturer. The example method may further include verifying the identity of the manufacturer prior to whitelisting the manufacturer. The example method may further include including the manufacturer in a list of manufacturers determined by the whitelisting authority. The example method may further include transmitting the whitelisted manufacturer to a PKI smart contract. The example method, where the signing keys are valid for a specific length of time. The example method, where the signing keys are configured to be renewed in order to be considered valid for a longer time. The example method may further include transmitting the signing keys to a PKI smart contract.

An example method may include generating a public/private keypair for a new device produced by a manufacturer; and saving the public/private keypair for the new device produced by the manufacturer. The example method, where the public/private keypair is generated by the manufacturer. The example method, where the method is performed by the manufacturer to certify new devices produced by the manufacturer. The example method, where the public/private keypair is fused in the hardware or saved in memory of the device. The example method, where the public/private keypair is saved with one of the manufacturer's registered keys.

An example method may include generating a random challenge, wherein the challenge is generated by a user, transmitting the challenge from the user to a device, receiving a reply to the challenge at the user from the device, verifying a signature of the reply received from the device, and verifying a certificate of the reply received from the device. The example method, where the method is performed to verify a device's certificate. The example method, where the challenge is generated by the user to determine whether the device is properly identifying itself and is associated with a correct manufacturer. The example method, where the challenge is a suite of randomly selected bytes. The example method may further include receiving the challenge at the device, generating a reply at the device, and transmitting the reply from the device to the user. The example method may further include signing the challenge before transmitting the reply. The example method, where verifying the signature comprises checking that a public key of the reply matches the challenge. The example method, where verifying the certificate comprises verifying that the certificate was signed by a manufacturer's non-revoked keys. The example method, where verifying the certificate comprises verifying that a public key was not blacklisted by a manufacturer. The example method, where verifying the certificate comprises verifying that a manufacturer's subscription is valid. The example method, where verifying the certificate comprises verifying that the device's identify is covered by a manufacturer's namespace. The example method may further include determining that the certificate is valid and verified.

An example method may include generating a revocation for a manufacturer at a whitelisting authority, signing the revocation by the whitelisting authority, and transmitting the revocation to a public ledger. The example method, where the revocation includes the manufacturer's public key. The example method may further include generating the manufacturer's certificate revocation. The example method, where the public ledger is a PKI smart contract.

An example method may include generating a revocation for a device at a manufacturer, signing the revocation by the manufacturer, and transmitting the revocation to a public ledger. The example method, where the revocation includes the device's public key. The example method may further include generating the device's certificate revocation. The example method, where the public ledger is a PKI smart contract.

An example method may include generating a whitelist at a whitelisting authority, adding the whitelist to a PKI smart contract, adding one or more signing keys to the PKI smart contract, provisioning a device with a keypair by a manufacturer, sending a challenge to the device from a user, receiving a reply from the device at the user, the reply including a challenge signature, and verifying a certificate and revocation status for the device by the user, wherein the certificate and revocation status is verified by the user using the PKI smart contract. The example method may further include determining a list of manufacturers and/or devices that are to be included in the whitelist. The example method may further include transmitting the whitelist to the PKI smart contract from the whitelisting authority. The example method, where the user includes a device associated with the user. The example method, where the manufacturer includes a device associated with the manufacturer.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. A method, comprising:
whitelisting a manufacturer by a whitelisting authority in response to a request by the manufacturer to be whitelisted; and
adding one or more signing keys for the manufacturer's devices, each of the signing keys corresponding to a device manufactured by the manufacturer.

2. The method of claim 1, further comprising verifying the identity of the manufacturer prior to whitelisting the manufacturer.

3. The method of claim 1, further comprising including the manufacturer in a list of manufacturers determined by the whitelisting authority.

4. The method of claim 1, further comprising transmitting the whitelisted manufacturer to a PKI smart contract.

5. The method of claim 1, wherein the signing keys are valid for a specific length of time.

6. The method of claim 1, wherein the signing keys are configured to be renewed in order to be considered valid for a longer time.

7. The method of claim 1, further comprising transmitting the signing keys to a PKI smart contract.

8. A method, comprising:
generating a public/private keypair for a new device produced by a manufacturer; and
saving the public/private keypair for the new device produced by the manufacturer.

9. The method of claim 8, wherein the public/private keypair is generated by the manufacturer.

10. The method of claim 8, wherein the method is performed by the manufacturer to certify new devices produced by the manufacturer.

11. The method of claim 8, wherein the public/private keypair is fused in the hardware or saved in memory of the device.

12. The method of claim 8, wherein the public/private keypair is saved with one of the manufacturer's registered keys.

13. A method, comprising:
generating a random challenge, wherein the challenge is generated by a user;
transmitting the challenge from the user to a device;
receiving a reply to the challenge at the user from the device;
verifying a signature of the reply received from the device; and
verifying a certificate of the reply received from the device.

14. The method of claim 13, wherein the method is performed to verify a device's certificate, wherein the certificate is stored in a hardware security module (HSM).

15. The method of claim 13, wherein the challenge is generated by the user to determine whether the device is properly identifying itself and is associated with a correct manufacturer.

16. The method of claim 13, wherein the challenge is a suite of randomly selected bytes.

17. The method of claim 13, further comprising:
receiving the challenge at the device;
generating a reply at the device; and
transmitting the reply from the device to the user.

18. The method of claim 17, further comprising signing the challenge before transmitting the reply.

19. The method of claim 13, wherein verifying the signature comprises checking that a public key of the reply matches the challenge.

20. The method of claim 13, wherein verifying the certificate comprises verifying that the certificate was signed by a manufacturer's non-revoked keys.
